(19) United States
(12) Patent Application Publication
(10) Pub. No.: US 2004/0097198 A1
(43) Pub. Date: May 20, 2004

(54) Voice-enabled mobile phone fixed line conversion apparatus

(75) Inventor: Stephen Chen, Chang-Hua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 10/298,051

(22) Filed: Nov. 18, 2002

(51) Int. Cl. H04B 1/40; H04M 1/00; H04B 1/38

(52) U.S. Cl. 455/74.1; 455/567

(57) ABSTRACT

A voice-enabled mobile phone fixed line conversion apparatus and particularly a conversion apparatus that enables a fixed line telephone to use mobile phones and has calling identification function mainly includes a conversion device connecting respectively to a fixed telephone line and a mobile phone. The conversion device consists of a microprocessor, a fixed line/mobile phone switch unit, a DTMF decoding unit, a caller identification voice unit, a fixed line detection unit and a mobile phone communication interface. The apparatus allows a fixed line telephone to take phone calls from mobile phones and hear the telephone number of the incoming phone calls.

### BACKGROUND OF THE INVENTION

1. Field of the Invention

The invention relates to a voice-enabled mobile phone fixed line conversion apparatus and particularly a conversion apparatus that enables a fixed line telephone to use mobile phones and includes calling identification function.

2. Description of the Prior Art

Mobile phone is very popular these days. In our country, the market penetration of mobile phone almost reaches 90%. While mobile phone offers great conveniences and many useful functions, its potential risks resulting from electromagnetic wave is a grave concern to many people. Some people try to use anti-magnetic wave stickers or handfree handsets to overcome this problem. However, the effect is dubious. Moreover, most people want to relax at home. To constantly carry the mobile phone indoors to avoid missing phone call is not desirable.

### SUMMARY OF THE INVENTION

The primary object of the invention is to provide a voice-enabled mobile phone fixed line conversion apparatus that combines the mobile phone network with a fixed line network to enable a fixed line telephone to receive or make mobile phone call.

Another object of the invention is to provide a voice-enabled mobile phone fixed line conversion apparatus that connects the mobile phone to a fixed telephone line to enable users to use a fixed line telephone to identify incoming telephone phone numbers to filter out unnecessary telephones.

The apparatus of the invention aims at overcoming the disadvantages of conventional mobile phones. It mainly includes a conversion device connecting respectively to a fixed line network and a mobile phone to integrate the mobile phone and the fixed line network to enable users to take incoming phone calls.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of the invention.

FIG. 2 is a schematic diagram of a first embodiment of the invention.

FIG. 3 is a structural block diagram of a second embodiment of the invention.

FIG. 4 is a structural block diagram of a third embodiment of the invention.

FIG. 5 is a structural block diagram of a fourth embodiment of the invention.

FIGS. 6A and 6B are the schematic diagrams of a fifth embodiment of the invention.

FIG. 7 is a schematic diagram of the fifth embodiment of the invention.

FIG. 8 is a structural block diagram of a sixth embodiment of the invention.

FIG. 9 is a structural block diagram of a seventh embodiment of the invention.

### DESCRIPTION OF THE PREFERRED EMBODIMENTS

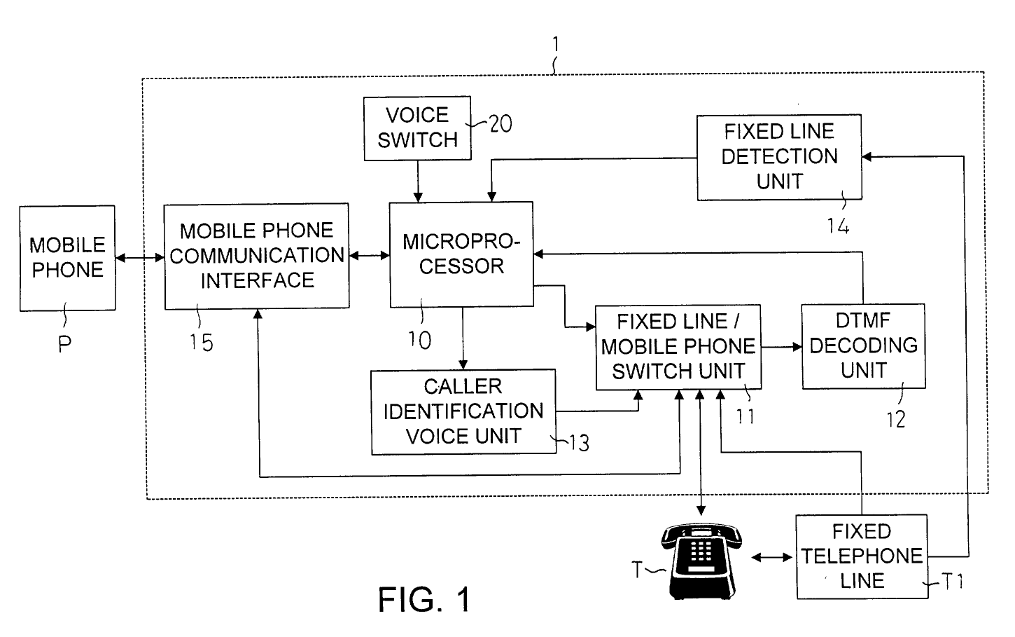

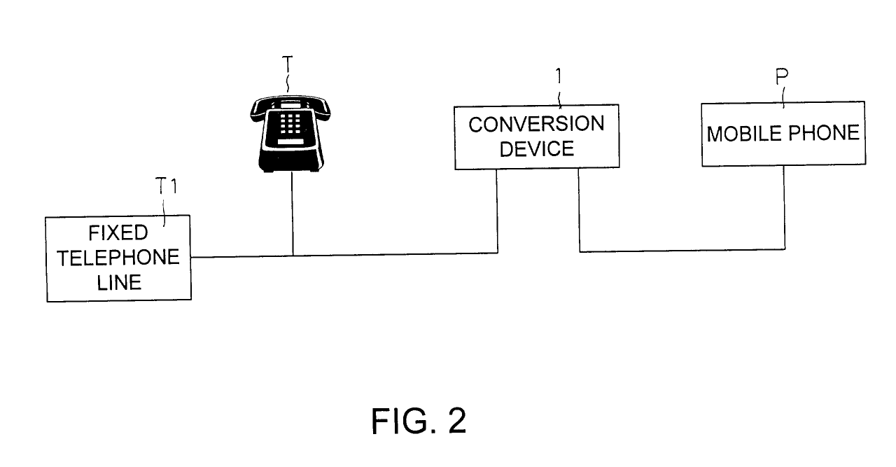

Referring to FIGS. 1 and 2, the invention mainly includes a conversion device 1 linking to a fixed telephone line T1, a fixed line telephone T and a mobile phone P.

The conversion device 1 consists of:

a microprocessor 10 which coordinates operations of various units of the conversion device 1 to control interactions between the mobile phone P the fixed telephone line T1 and the fixed line telephone T;

a fixed line/mobile phone switch unit 11 linking to the microprocessor 10 to receive control signals of the microprocessor 10 and select the fixed telephone line T1 or mobile phone lines;

a DTMF decoding unit 12 linking to the microprocessor 10 to transmit decoded signals to the microprocessor 10 for processing;

a caller identification voice unit 13 linking to the microprocessor 10 to transform incoming telephone numbers to voice for broadcasting in an audio fashion;

a fixed line detection unit 14 controlled by the microprocessor 10 to test the incoming phone calls and phone communication on the fixed telephone line T1, and through the microprocessor 10 to control the fixed line/mobile phone switch unit 11;

a mobile phone communication interface 15 linking to the microprocessor 10 to transmit and receive signals of the mobile phone P; and

a voice switch 20 for determining whether to hear the telephone voice of the incoming call before taking the incoming call.

By means of the construction set forth above, the conversion device 1 connects to the fixed telephone line T1 and connects to the mobile phone P through the mobile phone communication interface 15 to complete the installation of the invention. Users may use the voice switch 19 on the fixed line/mobile phone switch unit 11 to determine whether to hear the telephone voice of the incoming call before taking the incoming call. When the voice switch is in an ON condition and there is an incoming call from the mobile phone P, an user may take the handset of the fixed line telephone T, and the caller identification voice unit 13 generates the voice of the telephone number of the incoming call that is output on the handset of the fixed line telephone T through the fixed line/mobile phone switch unit 11 (while the telephone is still not yet hooked up). If the user decides to take the incoming call, he/she depresses a preset key (such as FLASH key or receive key) on the fixed line telephone T. If the user does not want to take the incoming call, he/she may hang up the fixed line telephone T. On the contrary, when the voice switch is in an OFF condition and there is an incoming call from the mobile phone P, the user may directly take the handset of the fixed line telephone T to take the incoming call.

In the event that there is an incoming call from the mobile phone P and the user uses the mobile phone to take the incoming call, in the mean time another incoming call is coming through the fixed line telephone T, an interruption tone may be heard on the mobile phone P. Then the user may decide whether to take the incoming call from the fixed line telephone T. If the user decides to take the call, he/she depresses the “#” key and uses the “#” key to switch between the mobile phone and the fixed telephone line T1.

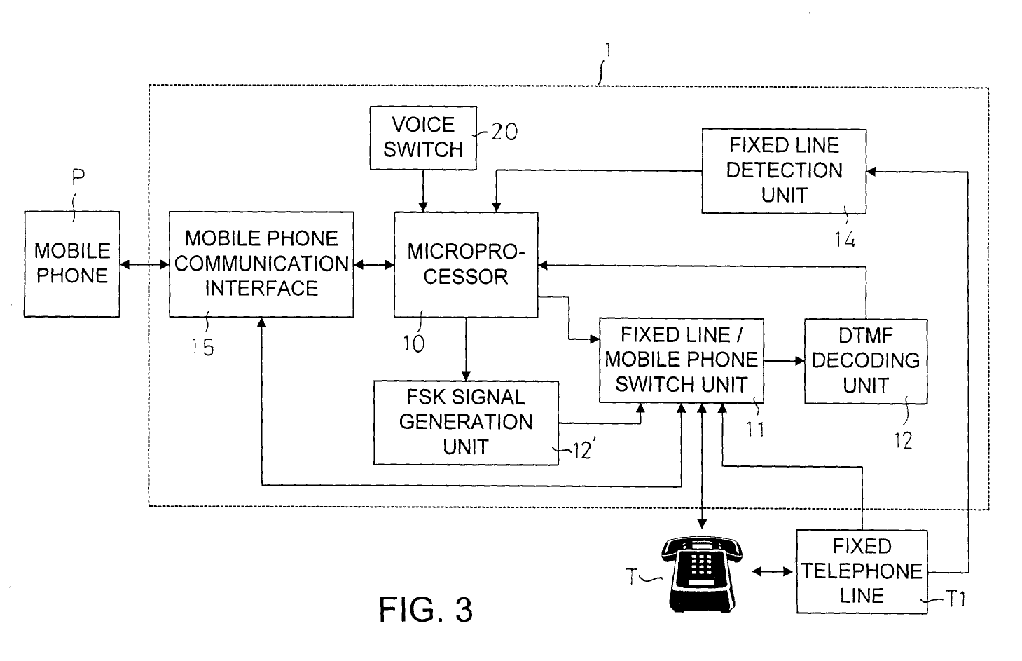

Refer to FIG. 3 for the structural block diagram of a second embodiment of the invention. In this embodiment a FSK signal generation unit 12′ that is able to transform the incoming phone number to a signal recognizable by the fixed line telephone replaces the caller identification voice unit 13 to enable the fixed line telephone to display the incoming phone number.

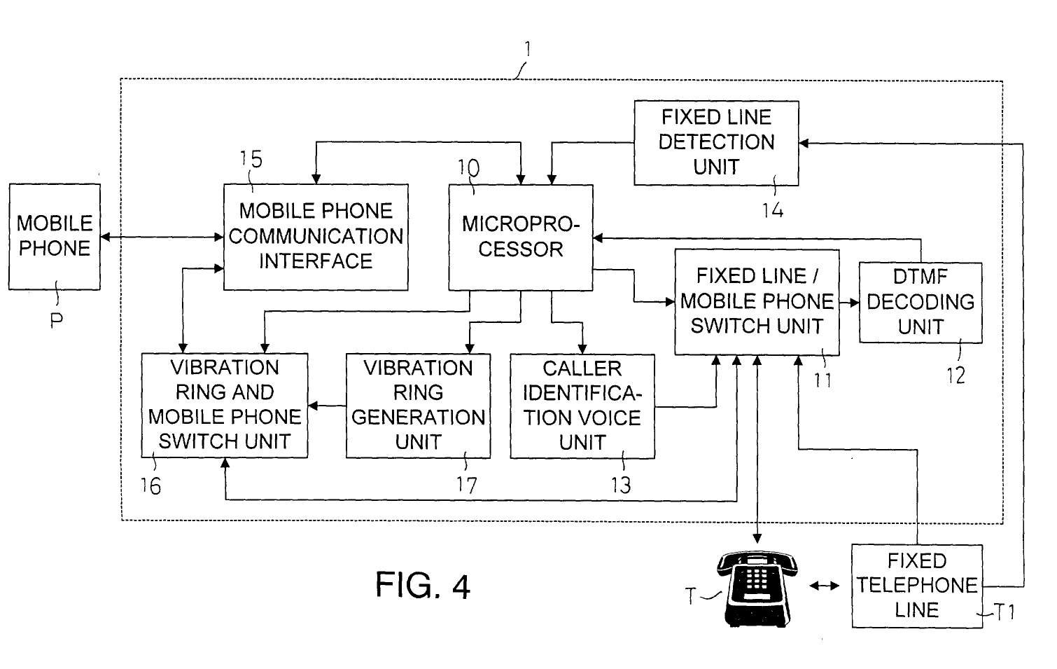

Refer to FIG. 4 for the structural block diagram of a third embodiment of the invention. In this embodiment a vibration ring generation unit 17 and a vibration ring and mobile phone switch unit 16 are added to the original conversion device 1, wherein:

the vibration ring generation unit 17 generates vibration ring signals to the vibration ring and mobile phone switch unit 16; and

the vibration ring and mobile phone switch unit 16 receives the vibration ring signals from the vibration ring generation unit 17 and is linked to the microprocessor 10 to determine whether to send the vibration ring signals to the fixed line/mobile phone switch unit 11 and to connect the mobile phone communication interface 15.

Through operations of the vibration ring generation unit 17 and the vibration ring and mobile phone switch unit 16, when there is an incoming call from the mobile phone P, the vibration ring and mobile phone switch unit 16 will output vibration signals to trigger the vibration ring generation unit 17 to generate vibration ring signals to the fixed line/mobile phone switch unit 11 to make the fixed line telephone T to generate vibration ring to avoid missing phone call due to too little ringing on the mobile phone P.

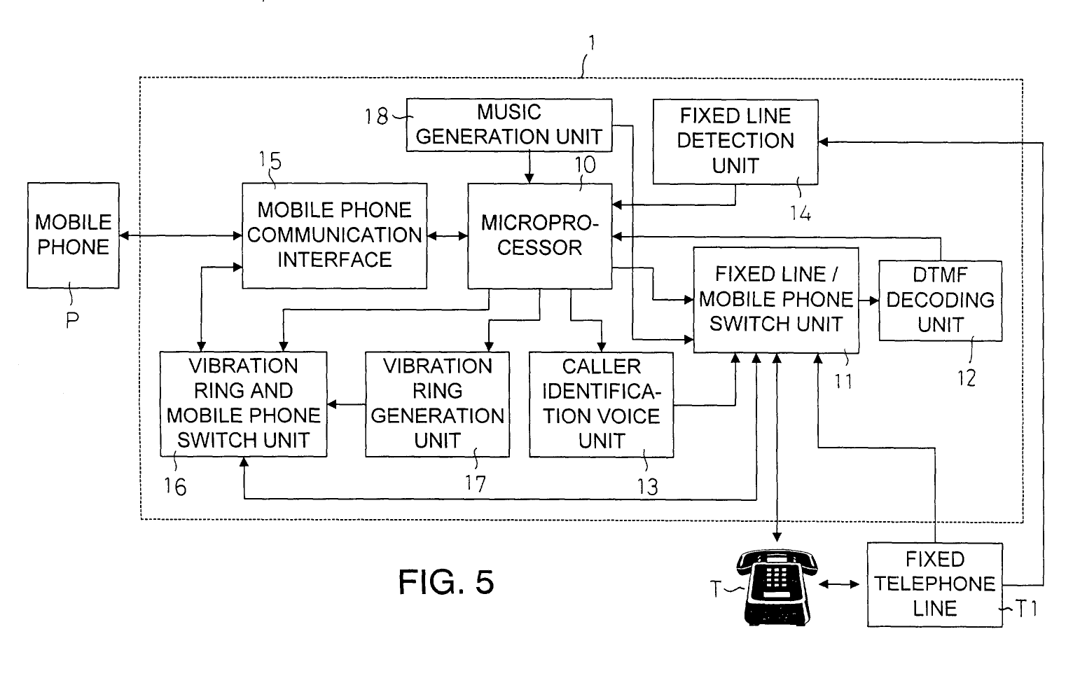

Refer to FIG. 5 for the structural block diagram of a fourth embodiment of the invention. In this embodiment a music generation unit 18 is added to the original conversion device 1. The music generation unit 18 enables the waiting telephone line to hear the resided music during the fixed line/mobile phone switch unit 11 is making switch. In other words, while the fixed telephone T is busy in use and there is an incoming call from the mobile phone P, an interruption tone will be produced. If the user wants to take the incoming call, he/she depresses the “#” key on the mobile phone P while another line will be held and hear the music output by the music generation unit 18. If the user wants to resume the conversation on another line, he/she needs only to depress again the transfer “#” key. If the user wants to hang up the fixed line telephone T after having finished the call and take the incoming call from the mobile phone P, he/she may depress the preset key (such as FLASH key) to make switch. Similarly, if the user wants to hang up the mobile phone P after having finished the call and take the incoming call from the fixed line telephone T, he/she may depress the preset key (such as FLASH key) to make switch. The user may also hang up both the fixed line telephone T and the mobile phone P by returning the handset to its home position.

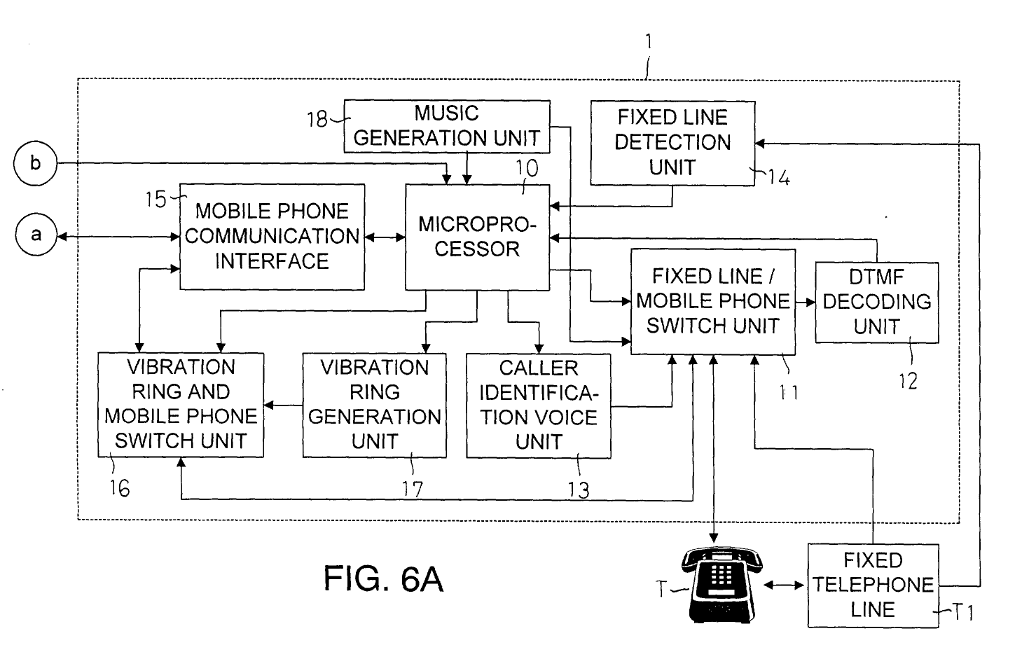

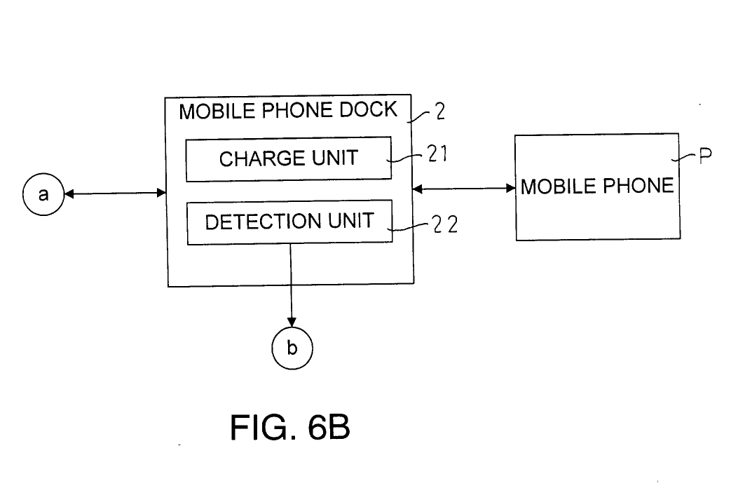

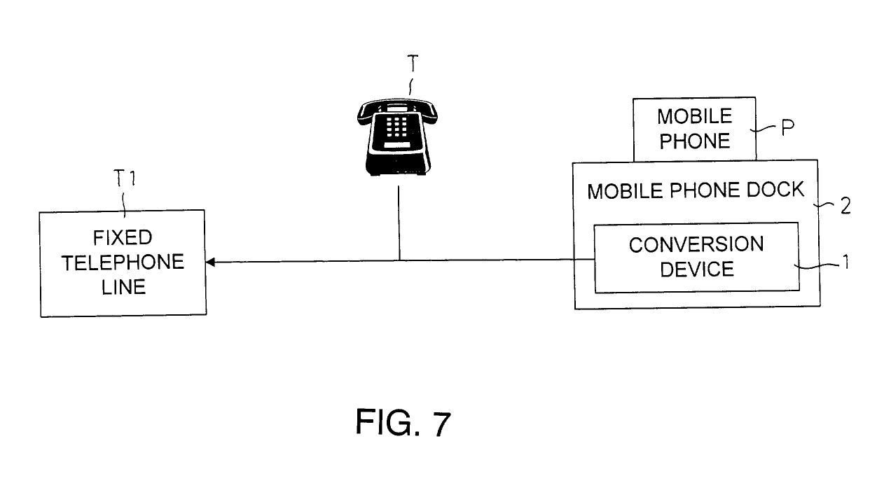

Referring to FIGS. 6A, 6B and 7 for the structural and schematic block diagrams of a fifth embodiment of the invention. In this embodiment a mobile phone dock 2 containing a charge unit 21, a detection unit 22 and a conversion device 1 is provided to hold the mobile phone P, wherein:

the charge unit 21 provides electric power for charging the battery of the mobile phone P and operation of the mobile phone P;

the detection unit 22 detects whether the mobile phone dock 2 has held the mobile phone P; and

the conversion device 1 which consists of the units set forth above. Details are omitted here.

The aforesaid construction provides electric power required for the mobile phone when in use and to charge the mobile phone battery as desired.

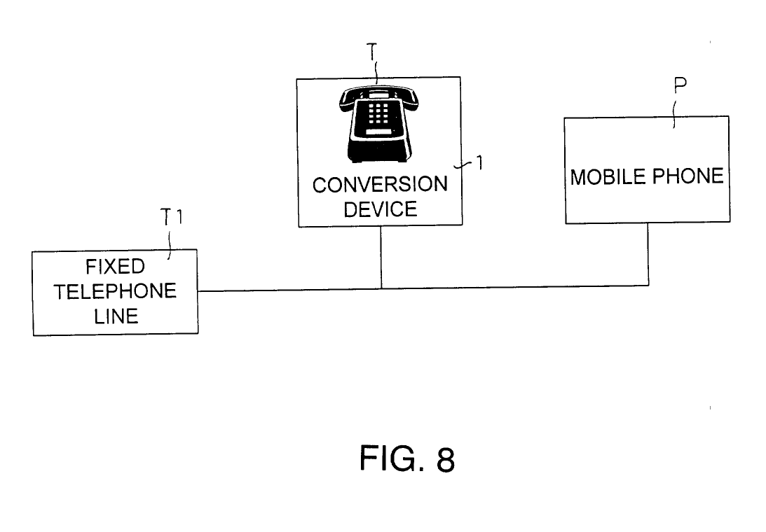

Refer to FIG. 8 for a schematic diagram of a sixth embodiment of the invention. The conversion device 1 is directly located in a fixed line telephone T to save installation troubles for users.

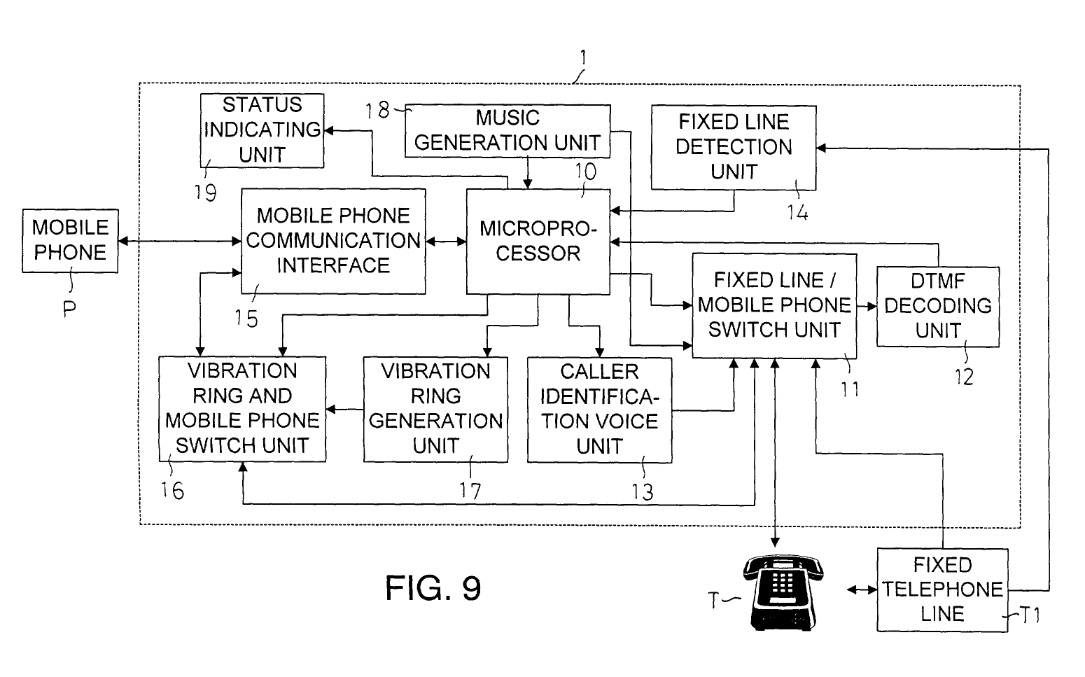

Refer to FIG. 9 for the structural block diagram of a seventh embodiment of the invention. In this embodiment a status indicating unit 19 is added to the conversion device 1. The status indicating unit 19 may include a plurality of LED lights (or a LCD device) to indicate operation status of the conversion device 1.

By means of the construction of the invention set forth above, a fixed line telephone may be used to take the incoming call from mobile phones to eliminate the threat of electromagnetic wave, and also can filter out unwanted phone calls.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A voice-enabled mobile phone fixed line conversion apparatus comprising a conversion device which connects to a fixed telephone line, a fixed line telephone and a mobile phone:
wherein the conversion device includes:
a microprocessor for coordinating operations of various units in the conversion device to control interactions between the mobile phone, the fixed telephone line and the fixed line telephone;
a fixed line/mobile phone switch unit linking to the microprocessor to receive control signals of the microprocessor and select the fixed telephone line or mobile phone lines;
a DTMF decoding unit linking to the microprocessor to transmit decoded signals to the microprocessor for processing;
a caller identification voice unit linking to the microprocessor to transform incoming telephone numbers to voice for broadcasting in an audio fashion;
a fixed line detection unit controlled by the microprocessor to test incoming phone calls and phone communication on the fixed telephone line, and through the microprocessor to control the fixed line/mobile phone switch unit; and
a mobile phone communication interface linking to the microprocessor to transmit and receive signals of the mobile phone;
wherein the fixed line telephone is allowed to take phone calls from the mobile phone and hear telephone numbers of the incoming phone calls.

2. The voice-enabled mobile phone fixed line conversion apparatus of claim 1, wherein the caller identification voice unit is replaced by a FSK signal generation unit which is linked to the microprocessor for transforming the incoming telephone numbers to signals recognizable by the fixed line telephone.

3. The voice-enabled mobile phone fixed line conversion apparatus of claim 1 or 2, wherein the conversion device further includes a voice switch to switch to hear the telephone voice of the incoming phone calls before taking the incoming phone calls.

4. The voice-enabled mobile phone fixed line conversion apparatus of claim 1 or 2, wherein the conversion device further includes:
a vibration ring generation unit for generating vibration ring signals to a vibration ring; and
a vibration ring and mobile phone switch unit for receiving the vibration ring signals from the vibration ring generation unit and being linked to the microprocessor to determine whether to send the vibration ring signals to the fixed line/mobile phone switch unit, and being connected the mobile phone communication interface.

5. The voice-enabled mobile phone fixed line conversion apparatus of claim 1 or 2, wherein the conversion device includes a music generation unit which enables a waiting telephone line to hear resided music during the fixed line/mobile phone switch unit is making switch.

6. The voice-enabled mobile phone fixed line conversion apparatus of claim 1 or 2 further having a mobile phone dock matching the conversion device.

7. The voice-enabled mobile phone fixed line conversion apparatus of claim 6, wherein the mobile phone dock includes a charge unit to provide electric power for mobile phone operation use and charging a mobile phone battery.

8. The voice-enabled mobile phone fixed line conversion apparatus of claim 1 or 2, wherein the conversion device is located in the fixed line telephone.

9. The voice-enabled mobile phone fixed line conversion apparatus of claim 1 or 2, wherein the conversion device includes a status indicating unit which has lighting to indicate the status of the conversion device.

10. The voice-enabled mobile phone fixed line conversion apparatus of claim 9, wherein the status indicating unit consists of a plurality of LED lights.

11. The voice-enabled mobile phone fixed line conversion apparatus of claim 9, wherein the status indicating unit consists of LCD devices.
